(19) United States
(12) Patent Application Publication
(10) Pub. No.: US 2017/0120428 A1
(43) Pub. Date: May 4, 2017

(54) SCREWDRIVER BIT DEVICE WITH A MAGNETIC STRUCTURE

(71) Applicant: Compass Corporation, Tainan City (TW)

(72) Inventor: Tzu-Chien Wang, Tainan City (TW)

(21) Appl. No.: 14/930,534

(22) Filed: Nov. 2, 2015

(51) Int. Cl. B25B 23/12; B25B 15/00

(52) U.S. Cl. CPC B25B 23/12; B25B 15/002

(57) ABSTRACT

A screwdriver bit device with a magnetic structure includes a screwdriver bit made of metal and including a shank having an insertion end on a front end thereof. The shank further includes an annular groove behind the insertion end. A sleeve is integrally made of plastic and includes an outer annular wall and a coupling portion surrounded by the outer annular wall. The coupling portion includes a hole through which the shank extends. The coupling portion of the sleeve further includes a flexible wall delimiting the hole and having a coupling section extending radially inwards. The coupling section is engaged in the annular groove of the screwdriver bit and slideable between front and rear stop faces of the annular groove. A magnetic ring is mounted to an inner side of a front end of the sleeve. The screwdriver bit extends through a through-hole of the magnetic ring.

### BACKGROUND OF THE INVENTION

The present invention relates to a screwdriver bit device with a magnetic structure and, more particularly, to a combination of a screwdriver bit and a magnetic ring for attracting a screw.

A typical screwdriver bit includes a shank having an insertion end with a Phillips head tip, a cabinet tip, or a polygonal tip for coupling a correspondingly shaped groove of a screw head. The insertion end of the screwdriver bit can be inserted into the groove of the screw head, and the screwdriver bit can then be rotated to tighten or loosen the screw. In order to provide easy operation, the insertion end is generally magnetized to attract the screw head. However, the magnetic attraction provided by the screwdriver bit is weak, such that the screw is apt to fall when the screwdriver bit is shaken.

In an approach to obviate the above disadvantage, a magnetic sleeve is mounted to a front end of a screwdriver bit and includes a through-hole through which the screwdriver bit extends. A magnetic member is fixed to a front end of the magnetic sleeve and includes balls biased by springs provided in the through-hole to press against an outer periphery of the screwdriver bit. The magnetic sleeve can be moved rearwards until the insertion end of the screwdriver bit is located in front of the magnetic sleeve for coupling with the groove in a screw. The magnetic sleeve can be moved forwards to permit the magnetic member to contact and attract the screw head, preventing falling of the screw.

However, manual operation for moving the magnetic sleeve forwards and rearwards relative to the screwdriver bit is not convenient. Furthermore, the balls and springs for coupling between the sleeve and the screwdriver bit result in an increase in the manufacturing costs. Furthermore, when the screwdriver bit is rotated to drive the screw for tightening a workpiece, the reactive force transmitted from the workpiece to the magnetic member tends to damage the magnetic member usually having a weak structure.

An objective of the present invention is to provide a screwdriver bit device with a magnetic structure to provide convenient operation and to reduce the number of elements.

Another objective of the present invention is to provide a screwdriver bit device with a magnetic structure for preventing a magnetic ring from wearing during tightening operation.

A further objective of the present invention is to provide a screwdriver bit device with a magnetic structure for avoiding damage by the reactive force during tightening operation.

A screwdriver bit device with a magnetic structure according to the present invention includes

### BRIEF SUMMARY OF THE INVENTION

A screwdriver bit device with a magnetic structure according to the present invention includes a screwdriver bit, a sleeve, and a magnetic ring. The screwdriver bit is made of metal and includes a shank having an insertion end on a front end thereof. The shank further includes an annular groove behind the insertion end. The annular groove includes a front stop face and a rear stop face spaced from the front stop face along a longitudinal axis of the shank. The sleeve is integrally made of plastic and includes an outer annular wall and a coupling portion surrounded by the outer annular wall. The coupling portion includes a hole. The shank of the screwdriver bit extends through the hole of the coupling portion. The coupling portion of the sleeve further includes a flexible wall delimiting the hole. The flexible wall includes a coupling section extending radially inwards. The coupling section is engaged in the annular groove of the screwdriver bit and is slideable in the annular groove of the screwdriver bit between the front and rear stop faces along the longitudinal axis of the shank. The magnetic ring includes a through-hole. The magnetic ring is mounted to an inner side of a front end of the sleeve. The screwdriver bit extends through the through-hole of the magnetic ring.

In an example, the coupling portion of the sleeve includes an inner annular wall. The hole is defined in a central portion of the inner annular wall. A connecting wall is disposed on a front end of the inner annular wall and is connected to the inner periphery of the outer annular wall. The inner annular wall includes a plurality of slits. Each slit extends along the longitudinal axis of the shank. The flexible wall is defined between two adjacent slits.

The sleeve can further include a lip formed on the front end of the inner side of the outer annular wall. The lip includes an inner side spaced from a front end face of the outer annular wall along the longitudinal axis of the shank by a spacing. The insertion end of the screwdriver bit is adapted to engage with a groove in a screw head of a screw. The screw head of the screw has a thickness smaller than the spacing. The magnetic ring is mounted between the lip and the connecting wall of the sleeve.

The present invention will become clearer in light of the following detailed description of illustrative embodiments of this invention described in connection with the drawings.

### DESCRIPTION OF THE DRAWINGS

FIG. 1 is an exploded, perspective view of a screwdriver bit device with a magnetic structure according to the present invention.

FIG. 2 is an exploded, cross sectional view illustrating coupling of the screwdriver bit device according to the present invention and a screw.

FIG. 3 is a perspective view of the screwdriver bit device and the screw of FIG. 2 after coupling.

FIG. 4 is a cross sectional view of the screwdriver bit device and the screw of FIG. 2 after coupling.

FIG. 5 is a diagrammatic cross sectional view illustrating tightening of the screw into a work piece.

### DETAILED DESCRIPTION OF THE INVENTION

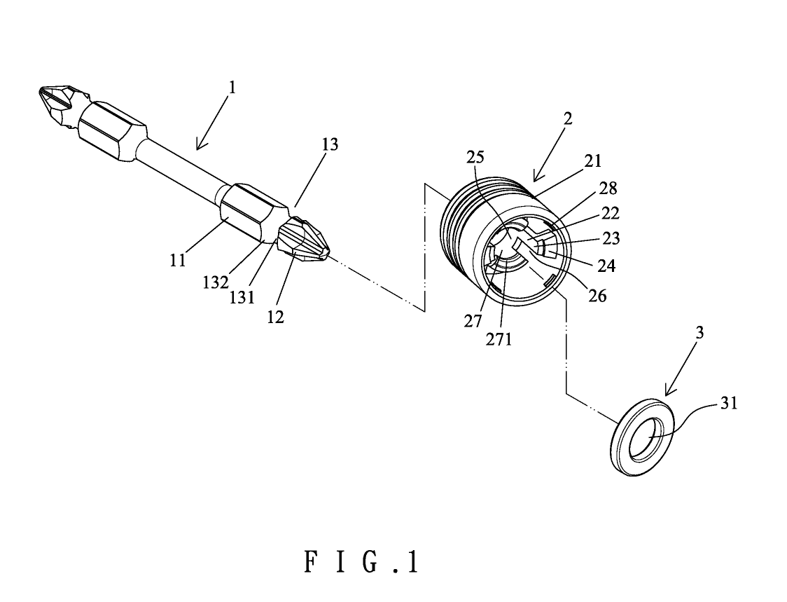

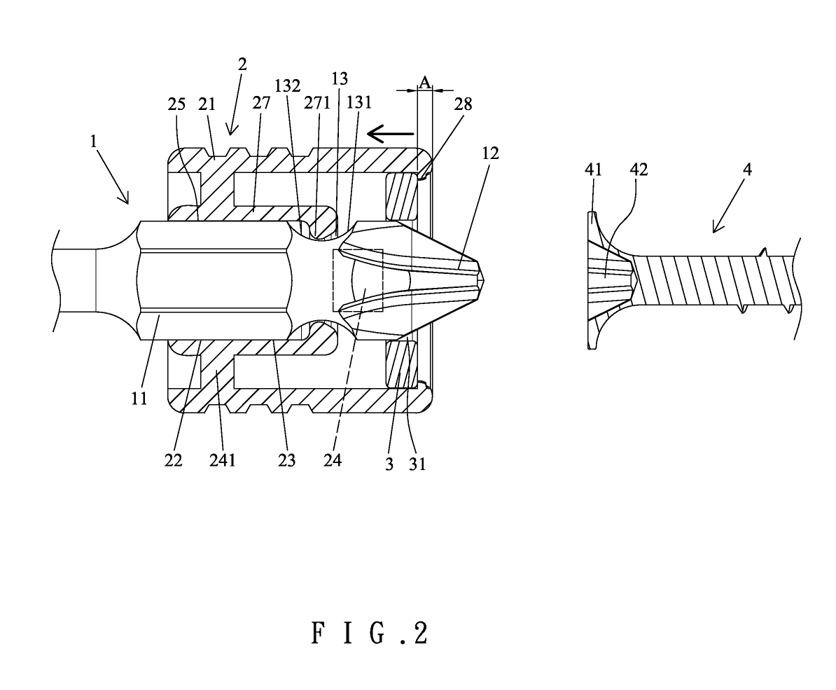

With reference to FIGS. 1 and 2, a screwdriver bit device with a magnetic structure according to the present invention includes a screwdriver bit 1, a sleeve 2, and a magnetic ring 3. The screwdriver bit 1 is made of metal and includes a shank 11 having an insertion end 12 on a front end thereof. The shank 11 further includes an annular groove 13 behind the insertion end 12. The annular groove 13 includes a front stop face 131 and a rear stop face 132 spaced from the front stop face 131 along a longitudinal axis of the shank 11. The spacing between the front and rear faces 131 and 132 permits movement of the sleeve 2 along the longitudinal axis of the shank 11.

The sleeve 2 is integrally made of plastic and includes an outer annular wall 21 and a coupling portion 22 surrounded by the outer annular wall 21. The coupling portion 22 is used to couple with the screwdriver bit 1. According to the form shown, the coupling portion 22 includes an inner annular wall 23. A connecting wall 24 is disposed on a front end of the inner annular wall 23 and is connected to the inner periphery of the outer annular wall 21. A connection wall 241 is disposed on a rear end of the inner annular wall 23 and is connected to the outer annular wall 21. The inner annular wall 23 includes a hole 25 in a central portion thereof. The shank 11 of the screwdriver bit 1 extends through the hole 25 of the coupling portion 22. The inner annular wall 23 further includes a plurality of slits 26. Each slit 26 extends along the longitudinal axis of the shank 11. In the form shown, a flexible wall 27 is defined between two adjacent slits 26 and includes a coupling section 271 extending radially inwards. The coupling section 271 engages in the annular groove 13 of the screwdriver bit 1 and is slideable in the annular groove 13 of the screwdriver bit 1 along the longitudinal axis of the shank 11. The sleeve 2 further including a lip 28 formed on the front end of the inner side of the outer annular wall 21. The inner side of the lip 28 is spaced from the front end face of the outer annular wall 21 along the longitudinal axis of the shank 11 by a spacing A.

In the form shown, the magnetic ring 3 is a permanent magnet and includes a through-hole 31 in a central portion thereof. The insertion end 12 of the screwdriver bit 1 extends through the through-hole 31 of the magnetic ring 3. The magnetic ring 3 is mounted to an inner side of the front end of the sleeve 2. By the flexibility of the outer annular wall 21 of the sleeve 2, the magnetic ring 3 is mounted between the lip 28 and the connecting wall 24 of the sleeve 2.

The screwdriver bit 1 can be forcibly inserted through the hole 25 of the sleeve 2, and the coupling section 271 is inserted into the annular groove 13 due to the flexibility of the flexible wall 27, preventing the sleeve 2 from disengaging from the screwdriver bit 1. When the insertion end 12 of the screwdriver bit 1 has not engaged with a screw 4 yet, the sleeve 2 is moved to a position in which the coupling section 271 abuts the rear stop face 132 of the annular groove 13 of the screwdriver bit 1 by the magnetic attraction between the magnetic ring 3 and the shank 11 of the screwdriver bit 1. In this case, a length of the insertion end 12 of the screwdriver bit 1 is exposed in front of the sleeve 2 to permit the insertion end 12 to align with an engagement groove 42 of a screw head 41 of the screw 4.

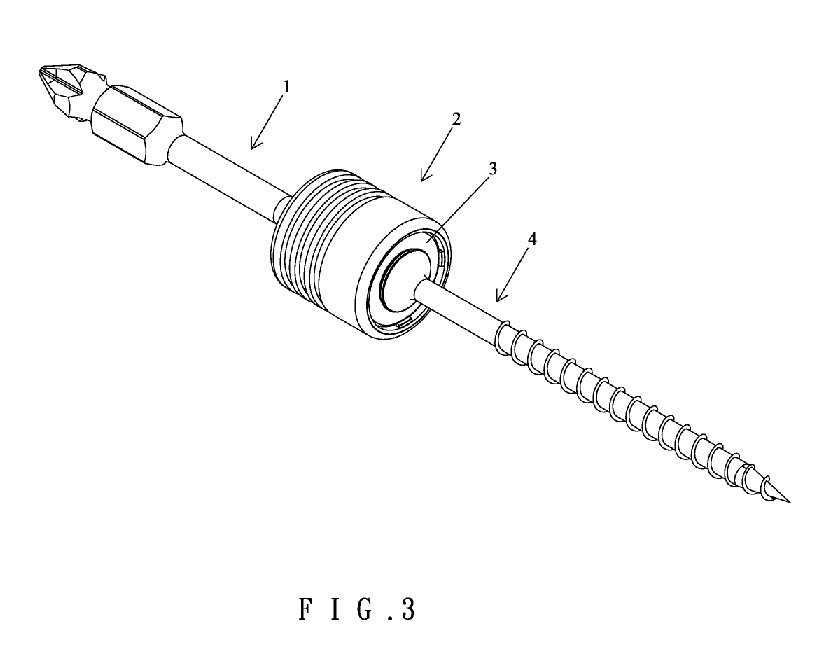

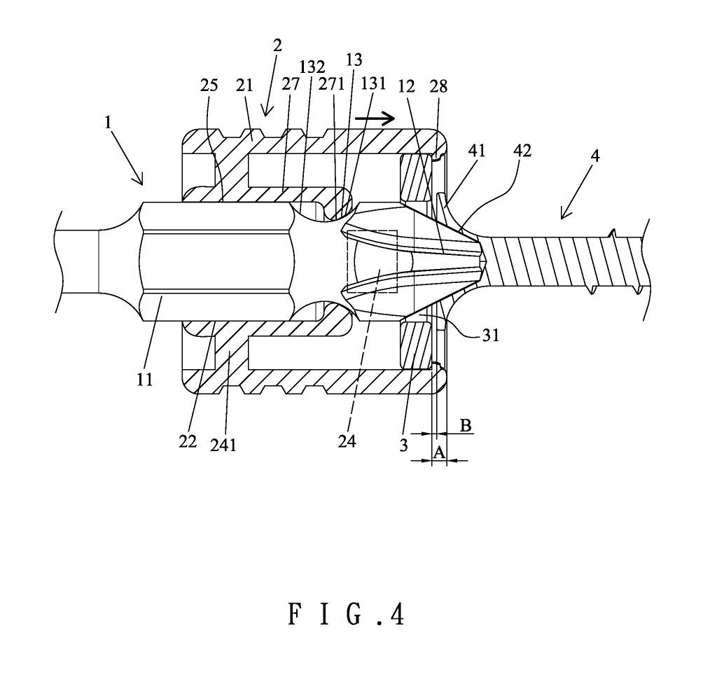

With reference to FIGS. 3 and 4, when the insertion end 12 of the screwdriver bit 1 is moved close to the screw head 41, the reduced spacing between the magnetic ring 3 and the screw head 41 causes the sleeve 2 to move forwards under the magnetic attraction. Thus, the insertion end 12 of the screwdriver bit 1 can be inserted into the engagement groove 42 of the screw head 41 while an end of the screw head 41 is securely attracted by the strong magnetic attraction of the magnetic ring 3, avoiding disengagement of the screw head 41. Furthermore, when the sleeve 2 moves forwards, the coupling section 271 of the flexible wall 27 abuts against the front stop face 131 of the annular wall 13 of the screwdriver bit 1, preventing further forward movement of the sleeve 2. The spacing A between the magnetic ring 3 and the front end face of the sleeve 2 is larger than the thickness B of the screw head 41 to avoid the magnetic ring 3 from contacting the screw head 41.

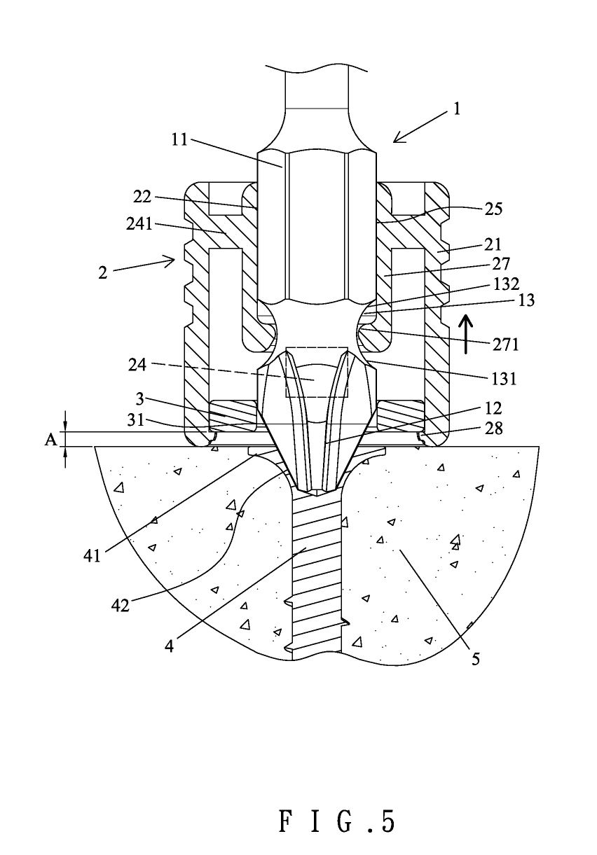

With reference to FIG. 5, when the screw 4 is rotated to tighten a workpiece 5 such as a wooden board, the reactive force from the screw 4 to the screwdriver bit 1 will not directly impact the magnetic ring 3, avoiding damage to the magnetic ring 3. Furthermore, when the end face of the screw 4 is driven to a position flush with an outer surface of the workpiece 5, the sleeve 2 can move rearwards to avoid the front end of the sleeve 2 from pressing against the outer surface of the workpiece 5, avoiding the outer surface of the workpiece 5 from wear.

When it is desired to disengage the screwdriver bit 1 from the screw 4 after tightening, the sleeve 2 can be moved rearwards under the magnetic attraction between the magnetic ring 3 and the shank 11 of the screwdriver bit 1 to a position (see FIG. 2) in which the coupling section 271 abuts the rear stop face 132 of the annular groove 13 of the screwdriver bit 1. Thus, the screwdriver bit 1 is ready for driving another screw 4.

The sleeve 2 according to the present invention includes the integrally formed flexible wall 27 and the integrally formed coupling section 271 to engage with the screwdriver bit 1. The springs and balls required in the conventional design are not required, reducing the number of elements and the assembling costs. Furthermore, the sleeve 2 can move automatically under the magnetic attraction of the magnetic ring 3 to provide operational convenience. Furthermore, the magnetic ring 3 does not directly contact the screw 4 during tightening of the screw 4 to avoid damage to the magnetic ring 3 resulting from vibrations.

Although specific embodiments have been illustrated and described, numerous modifications and variations are still possible without departing from the scope of the invention. The scope of the invention is limited by the accompanying claims.

1. A screwdriver bit device with a magnetic structure, comprising:
a screwdriver bit made of metal and including a shank having an insertion end on a front end thereof, with the shank further including an annular groove behind the insertion end, with the annular groove including a front stop face and a rear stop face spaced from the front stop face along a longitudinal axis of the shank;
a sleeve integrally made of plastic and including an outer annular wall and a coupling portion surrounded by the outer annular wall, with the coupling portion including a hole, with the shank of the screwdriver bit extending through the hole of the coupling portion, with the coupling portion of the sleeve further including a flexible wall delimiting the hole, with the flexible wall including a coupling section extending radially inwards, with the coupling section engaged in the annular groove of the screwdriver bit and slideable in the annular groove of the screwdriver bit between the front and rear stop faces along the longitudinal axis of the shank; and
a magnetic ring including a through-hole, with the magnetic ring mounted to an inner side of a front end of the sleeve, and with the screwdriver bit extending through the through-hole of the magnetic ring.

2. The screwdriver bit device with a magnetic structure as claimed in claim 1, with the coupling portion of the sleeve including an inner annular wall, with the hole defined in a central portion of the inner annular wall, with a connecting wall disposed on a front end of the inner annular wall and connected to the inner periphery of the outer annular wall, with the inner annular wall including a plurality of slits, with each of the plurality of slits extending along the longitudinal axis of the shank, and with the flexible wall defined between two adjacent slits.

3. The screwdriver bit device with a magnetic structure as claimed in claim 2, with the sleeve further including a lip formed on the front end of the inner side of the outer annular wall, with the lip including an inner side spaced from a front end face of the outer annular wall along the longitudinal axis of the shank by a spacing, with the insertion end of the screwdriver bit adapted to engage with a groove in a screw head of a screw, with the screw head of the screw having a thickness smaller than the spacing, and with the magnetic ring mounted between the lip and the connecting wall of the sleeve.
